(19) United States
(12) Patent Application Publication
(10) Pub. No.: US 2025/0159328 A1
(43) Pub. Date: May 15, 2025

(54) CAMERA COMPONENT

(71) Applicant: Arnold & Richter Cine Technik GmbH & Co. Betriebs KG, München (DE)

(72) Inventor: Leonard PREYMANN, Korneuburg (AT)

(21) Appl. No.: 18/941,654

(22) Filed: Nov. 8, 2024

(30) Foreign Application Priority Data
Nov. 10, 2023 (DE) 102023131319.3

(51) Int. Cl. H04N 23/60

(52) U.S. Cl. CPC H04N 23/60

(57) ABSTRACT

A camera component has a communication device for transmitting control signals and/or status signals, said communication device comprising a control unit and at least one electrical terminal, wherein the electrical terminal has at least two energy supply contacts and at least two signal contacts, and wherein the control unit is configured to perform the following steps when the communication device is connected to a further communication device of a further camera component via the electrical terminal:
performing a first check whether a communication in accordance with a first protocol is possible with the further communication device;
then, performing a second check whether a communication in accordance with a second protocol is also possible with the further communication device; and
in the event of a positive result of the second check, establishing a communication with the further communication device in accordance with the second protocol.

The invention relates to a camera component that is formed by a motion picture camera or an accessory device for a motion picture camera, said camera component comprising a communication device for transmitting control signals and/or status signals of the camera component, wherein the communication device comprises a control unit and at least one electrical terminal, wherein the electrical terminal has at least two energy supply contacts and at least two signal contacts.

Motion picture cameras are, for example, used in the production of cinema films, television films and streaming service films, wherein electronic motion picture cameras are often used. An electronic motion picture camera typically comprises an integrated optical system (camera objective, camera lens) or a lens mount to be able to selectively connect a respective interchangeable lens (interchangeable objective) that is adapted to specific recording situations. To be able to record the images captured by means of the optical system, an electronic image sensor for generating image signals from incident light and an image signal processing device for converting the image signals into a digital image data stream are usually provided.

A remote control device may in this respect be provided to be able to control an electronic motion picture camera (in particular a video camera) or a conventional motion picture camera (in particular a film camera) to record motion picture sequences and/or to be able to set recording parameters or change them during a recording. A cameraman guiding the motion picture camera thereby only has to ensure the correct and possibly varying alignment of the camera for recording a desired image section, while the corresponding setting of the recording parameters may be taken over by a further person, a camera assistant or a focus puller. For example, provision may be made to adapt the frame rate, the shutter speed, the aperture (f-stop), the focus distance or the focus, or the focal length (zoom factor) of the camera lens in a remote-controlled manner and in particular in a sequence during a recording previously agreed between the cameraman and the user of the remote control device.

The setting of parameters of the camera, in particular of the aperture, the focus distance and the focal length, may take place via respective lens setting motors that may be integrated into the camera lens or that may be arranged as separate, external units outside the camera lens. Such a lens setting motor may be connected to a rotatable lens ring of the camera lens so that the respective parameter may be changed by rotating the lens ring by means of the lens setting motor. Thus, a remote-controlled setting of the recording parameters may take place by transmitting setting signals to the respective lens setting motor by means of a remote control device in order to transfer the associated lens ring into a desired rotational position. Such a remote control device is, for example, known from DE 196 29 484 A1 and WO 2010/046237 A1. Furthermore, DE 42 19 331 A1, for example, shows a remote control device for setting different recording parameters before and in particular during a motion picture recording by controlling respective lens setting motors.

The aforementioned setting motors form accessory devices for the respective motion picture camera. A remote control device, which is, for example, connected by cable to the motion picture camera or a further accessory device, may in turn form an accessory device for a motion picture camera. Likewise, for example, a setting motor for a camera holder, in particular for a motorized drive of the camera in the pan and/or tilt direction, as known from U.S. Pat. No. 5,963,749 A, is a possible accessory device of the motion picture camera.

The signals to be transmitted by the aforementioned communication device may, for example, be control signals for the camera component (e.g. desired values for a setting motor) and/or status signals of the camera component (e.g. actual values of a setting motor or of a position sensor of a camera lens).

A transmission of control signals and/or status signals may therefore take place between different camera components that are equipped with respective, mutually matching communication devices. The communication may take place in accordance with a communication protocol. A common communication protocol is the Controller Area Network (CAN) protocol that is specified in many kinds of variants and further developments, in particular in accordance with the ISO 11898 standard. A communication in accordance with a communication protocol, in particular the CAN protocol, makes it possible to set up a serial bus system for signal transmission between a plurality of camera components.

One advantage of a serial bus system, in particular a CAN bus, is that the cabling effort is only relatively low and that message collisions are avoided. Error recognition mechanisms such as bit stuffing, frame check and cyclic redundancy check enable a high degree of robustness and security. Each device in the bus system may communicate independently with the other bus participants. Furthermore, it is advantageous that such a bus system may be easily expanded by further bus participants. The bus participants may in particular be plug and play capable so that laborious installation and setting processes are dispensed with. The energy supply contacts make it possible that the energy supply of the camera components also takes place via the communication devices.

Users want ever more powerful and flexible camera components, which often goes hand in hand with higher data rates with regard to the communication. For example, high data rates are becoming ever more important for focus setting motors to ensure a sufficiently high resolution at high setting speeds. However, the commonly used bus systems, in particular the widespread CAN bus systems, are not designed for high transmission frequencies.

To enable higher data rates, a switch to a particularly broadband protocol could be made in principle. However, this would exclude existing camera components, for example comprising CAN-based communication devices, from further use. A user would therefore have to convert an entire set of existing camera components to a new communication system, which would involve high acquisition costs.

It is an object of the invention to enable a faster and more flexible communication of camera components while avoiding high acquisition costs.

According to the invention, the control unit of the communication device of the camera component is configured to perform the following steps when the communication device is connected to a further communication device of a further camera component via the electrical terminal or via one of a plurality of electrical terminals:
performing a first check whether a communication in accordance with a first protocol is possible with the further communication device;
then, performing a second check whether a communication in accordance with a second protocol is also possible with the further communication device; and
in the event of a positive result of the second check, establishing a communication with the further communication device in accordance with the second protocol.

A camera component according to the invention is capable of communicating both via a first protocol and via a second protocol. The first protocol may be a protocol that is widely used, but relatively slow. The second protocol may be a relatively fast protocol compared to the first protocol. If the communication partner is capable of also communicating in accordance with the second protocol, this is determined during the second check. In the event of a positive result of the second check (as a necessary condition or directly as a sufficient condition), a communication with the further communication device may be established in accordance with the second protocol and the further communication may be carried out via the second protocol. This not only enables a particularly high bandwidth, for example 100 MBit/s with a cable length of up to 15 m in the case of an SPE protocol, but also the use of additional functions such as the provision of metadata and time stamps. Based on the first check, a camera component according to the invention, however, also recognizes a connected camera component that may communicate solely via the first protocol. This means that a camera component according to the invention is downwardly compatible in that it may communicate both with modern devices in accordance with the second protocol and with older devices in accordance with the first protocol. A particular advantage here is that no separate terminals and connection cables have to be provided for the communication in accordance with the first protocol and the communication in accordance with the second protocol since the common energy supply contacts and signal contacts as well as existing (for example four-pole) connection cables may be used for both protocols.

The camera component according to the invention may be a motion picture camera or an accessory device for a motion picture camera. The further camera component with which a communication is to be established may also be a motion picture camera or an accessory device for a motion picture camera. The respective accessory device may, for example, comprise an (integrated or external) setting motor for a camera lens, a motorized optical filter (for example a polarization filter rotatable in a motorized manner), a motor-adjustable camera holder (for example a motorized tripod head with a drive in the pan and/or tilt direction), a camera stabilization device (for example a gimbal stabilized in a motorized manner), an image stabilization device (for example an electrically controlled optical image stabilization of a motion picture camera or a lens), a remote control device (as already explained above) or a film set lighting device (for example a controllable spotlight).

The first protocol may in particular be a Controller Area Network (CAN) protocol. This protocol is widely used in its variants and further developments so that numerous existing camera components may be coupled to the camera component according to the invention.

The second protocol may, for example, be a network protocol capable of transmitting time stamps, in particular an Internet Protocol (IP) in its various variants and further developments. If the second protocol is capable of also transmitting associated time data in addition to pure values (e.g. desired values, actual values, sensor values), this opens up new application possibilities for existing camera components in modern film technology since a subsequent linking with time accuracy of image data of a used motion picture camera with recording parameters (e.g. focus distance of the lens, position or orientation of the motion picture camera in space) is possible. This is important, for instance, in post-production in the event of a virtualization of the recording environment.

According to a preferred embodiment, the second protocol may be a Single Pair Ethernet (SPE) protocol. An SPE protocol is designed for the transmission of Ethernet via a single pair of copper cores. The SPE protocol may be specified in accordance with the IEEE 802.3 standard, in particular the IEEE 802.3cg (10Base-T1) standard. A communication in accordance with an SPE protocol has the advantage that, compared to historically widespread protocols (such as a CAN protocol), not only a relatively fast data transmission and a transmission of metadata and time stamps are possible. Rather, the communication may take place via a small number of electrically conductive cores, in particular via only two cores, so that the historically widespread cables may also be used for a communication in accordance with the SPE protocol. In particular, the cables, plugs and sockets that are also used for a communication in accordance with the CAN protocol may generally be used for this purpose, wherein at most minor adaptations with respect to the impedance are necessary.

In a camera system that comprises a motion picture camera and a plurality of accessory devices of the motion picture camera, it may also be sufficient for the communication device of individual camera components to comprise only a single electrical terminal, while the communication devices of other camera components each comprise at least two electrical terminals. If the communication device of a camera component (such as the motion picture camera itself or a motorized optical filter) comprises only a single electrical terminal, this camera component may in particular form the last link in a serial bus arrangement.

As regards the control unit of the communication device, it may be configured to automatically recognize the connection of the communication device via the respective electrical terminal to a further communication device of a further camera component, for example by monitoring the contacts, as is generally known in hot plugging methods.

The control unit may be configured, in the event of a positive result of the first check, to at least temporarily establish a communication with the further communication device in accordance with the first protocol (e.g. CAN protocol). A bus system formed by the communication devices may hereby be set up temporarily, completely or partially. A communication option via the first protocol is thus immediately used. The second check may then—just like additional checks that may have to be performed—be performed using the first protocol. If the other communication device may communicate via both the first protocol and the second protocol, the existing ability to also be able to communicate via the second protocol may be communicated via the connection in accordance with the first protocol. The communication devices of the camera component and the further camera component may thus negotiate a subsequent use of the second protocol using the first protocol.

If the communication between the communication devices takes place in accordance with the first protocol, the (at least two) signal contacts of the respective electrical terminal may be used for the transmission of signals and the (at least two) energy supply contacts may serve to supply the communication device or the respective communication device with electrical energy. The same applies if the communication between the communication devices takes place in accordance with the second protocol; alternatively thereto, in the case of a communication in accordance with the second protocol, an energy supply may take place via the signal contacts of the respective electrical terminal.

According to one embodiment of the invention, the control unit is configured to repeat the first check in the event of a negative result of the first check. It is therefore possible to wait until a communication in accordance with the first protocol (for example a CAN-based communication) is possible at all so that the first protocol therefore serves as a secure entry protocol. All devices that are at least capable of a communication in accordance with the first protocol, which applies to many existing camera components, may be used in a corresponding camera system.

In other embodiments, the control unit may be configured to perform the second check in the event of a negative result of the first check. In this embodiment, in the event that a communication in accordance with the first protocol (for example a CAN communication) is not possible, a communication in accordance with the second protocol is attempted “on the off chance”, so to speak. This is particularly efficient in camera application environments in which camera components based primarily or exclusively on either the first protocol or the second protocol are used.

In some embodiments, the establishing of a communication with the further communication device in accordance with the second protocol comprises the communication device and the further communication device negotiating a master/slave assignment. This facilitates the administration of access to the common transmission channel. A master/slave assignment is to be understood as a defined hierarchy based on which one of the communication devices has a higher-priority right to transmit signals.

In some embodiments, the control unit of the communication device may comprise at least one controller (e.g. a microcontroller), at least a first transceiver corresponding to the first protocol (e.g. a CAN transceiver), at least a second transceiver corresponding to the second protocol (e.g. an SPE transceiver) and at least one switching device, wherein the switching device is configured to selectively couple the first transceiver or the second transceiver to the (at least two) signal contacts of the (at least one) electrical terminal of the communication device in order to transmit signals via this electrical terminal, and wherein the controller is configured to control the coupling of the first transceiver and the second transceiver to the signal contacts of the communication device. Thus, it is possible to switch between the first transceiver and the second transceiver quickly and easily. A transceiver is to be understood as the combination of an electronic receiver and an electronic transmitter, in particular for a wired signal transmission, wherein the signal transmission takes place, for example, in accordance with a CAN protocol in a CAN transceiver and in accordance with an SPE protocol in an SPE transceiver. The first transceiver, the second transceiver and the controller may have respective integrated circuits. The first transceiver and the second transceiver ensure a conversion of the transmission signals into logical signals and prevent excess voltages. The switching device may have one or more transistors or one or more relays that are connected to the controller and the electrical terminal.

The transmitted signals may comprise signals for establishing the connection and the aforementioned control signals and/or status signals of the camera component as well as associated metadata and/or time stamps.

The controller of the communication device may be configured to control a transmission of signals between a plurality of terminals, in particular two terminals, of the communication device.

According to one embodiment of the invention, the communication device of the camera component may have two electrical terminals of said kind (i.e. in each case comprising at least two energy supply contacts and at least two signal contacts) and an interface for a signal transmission between the communication device and a component function control unit of the camera component. In such an embodiment, said controller of the communication device may be configured to control a transmission of signals between the two terminals of the communication device and/or between one of the two terminals and the interface of the communication device. The component function control unit may be a component-specific control unit that controls the mode of operation of the camera component based on the transmitted signals. For example, the motor control of a lens setting motor or the basic control unit of a camera may form a component function control unit. The interface of the camera component enables a signal-wise coupling of the component function control unit of the camera component to its communication device so that all control and status signals that are necessary for the operation of the camera component may be transmitted to one or more connected camera components.

The control unit of the communication device may have a first transceiver (for example a CAN transceiver) and a second transceiver (for example an SPE transceiver) for each electrical terminal (in particular for each of two or more electrical terminals). It is thereby possible to selectively establish a connection in accordance with the first protocol or a connection in accordance with the second protocol via each electrical terminal.

The control unit may have a respective switching device for each of a plurality of (for example two) electrical terminals or a common switching device for a plurality of (for example two) electrical terminals. Furthermore, the control unit may have a respective controller for each of a plurality of (for example two) electrical terminals or a common controller for a plurality of (for example two) electrical terminals.

The communication device of the camera component may have at least one signal converter. The signal converter may in particular be part of said controller of the communication device of the control unit or may be formed separately therefrom. The signal converter may be configured to selectively convert a signal received in accordance with the first protocol (for example a CAN signal) into a signal in accordance with the second protocol (for example an SPE signal) or to convert a signal received in accordance with the second protocol (for example an SPE signal) into a signal in accordance with the first protocol (for example a CAN signal). The controller of the communication device may be configured to control the signal converter to convert a signal received at an electrical terminal in accordance with the first protocol into a signal in accordance with the second protocol in order to output the signal in accordance with the second protocol at another electrical terminal of the communication device; and/or to control the signal converter to convert a signal received at an electrical terminal in accordance with the second protocol into a signal in accordance with the first protocol in order to output the signal in accordance with the first protocol at another electrical terminal of the communication device. In this embodiment, the communication device of the camera component may fulfill an adapter function. For example, in a serial coupling of camera components according to the daisy chain principle, an SPE signal that is output by one of the camera components may be converted by the following camera component into a CAN signal and may then be output to a further downstream camera component. For example, a camera component with only CAN capability may be included in a series of SPE-capable camera components in this way, wherein the camera component with only CAN capability is preferably to be placed at the end of the chain that faces away from the control.

According to a further embodiment of the invention, the control unit is configured to perform an assessment of the signal transmission quality after establishing a communication with the further communication device in accordance with the second protocol and, in the event of a negative result of the assessment, to establish a communication with the further communication device in accordance with the first protocol instead of the second protocol. This takes into account the circumstance that a connection in accordance with the first protocol (for example a CAN connection) may be slower, but more robust than a connection in accordance with the second protocol (for example an SPE connection) and in particular allows longer cable lengths. The assessment of the signal transmission quality represents a quality check, on the basis of which situations may be recognized that are problematic for a connection in accordance with the second protocol. In such situations, for example when a cable length of 15 m is exceeded, it is advantageous to make use of the first protocol despite the basic ability of both communication partners to establish a connection in accordance with the second protocol. The assessment may comprise comparing a measured data rate with a threshold value, wherein, for example, a falling below of the threshold value is to be regarded as a negative result of the assessment. Such an assessment of the signal transmission quality may thus represent an additional criterion in order, in the event of a positive result of said second check, to actually establish a communication with the connected further communication device in accordance with the second protocol.

It is preferred that the respective electrical terminal of the communication device (in particular each of a plurality of—for example two—electrical terminals of the communication device) has only the two energy supply contacts and only the two signal contacts. It is thereby possible to use four-pole connection cables that are particularly light and compact. Furthermore, the size of the terminal plugs and the terminal sockets may be kept to a minimum. Both for, for example, the CAN protocol and for, for example, the SPE protocol, two energy supply lines and two signal lines are generally sufficient.

Further developments of the invention can also be seen from the dependent claims, from the description and from the enclosed drawings.

The invention will be described in the following by way of example with reference to the drawings.

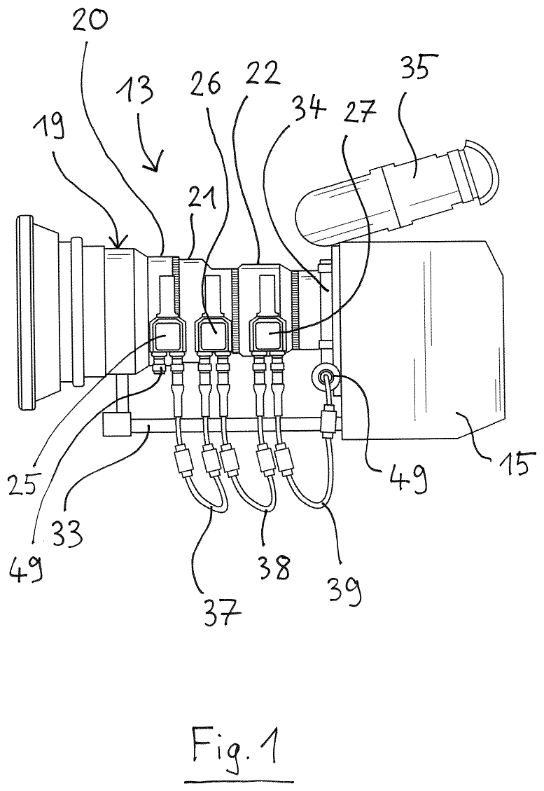

FIG. 1 is a representation of a motion picture camera comprising a plurality of lens setting motors;

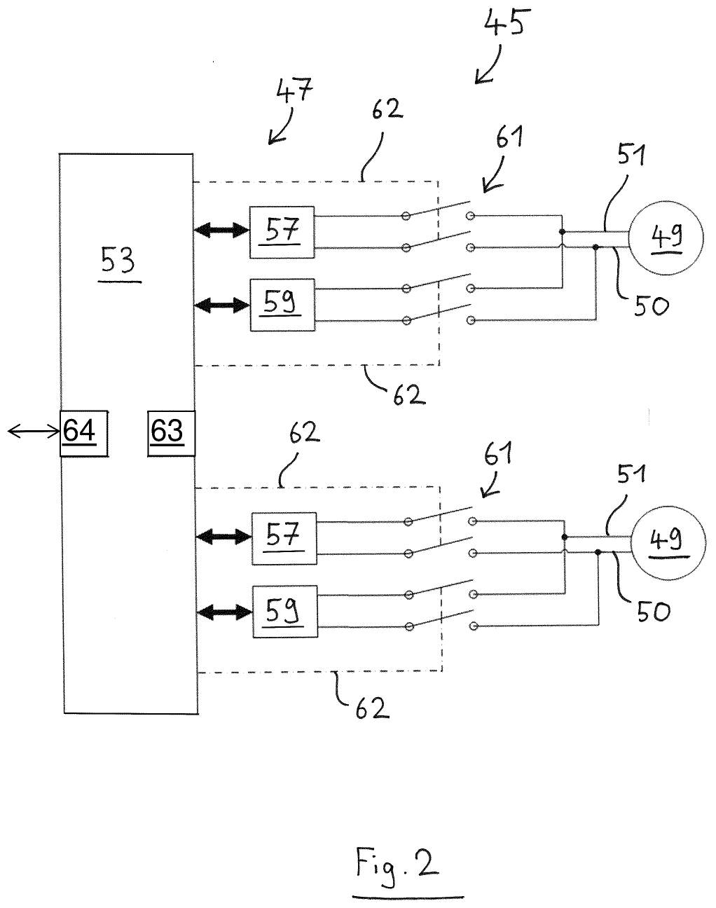

FIG. 2 shows a communication device of one of the lens setting motors shown in FIG. 1;

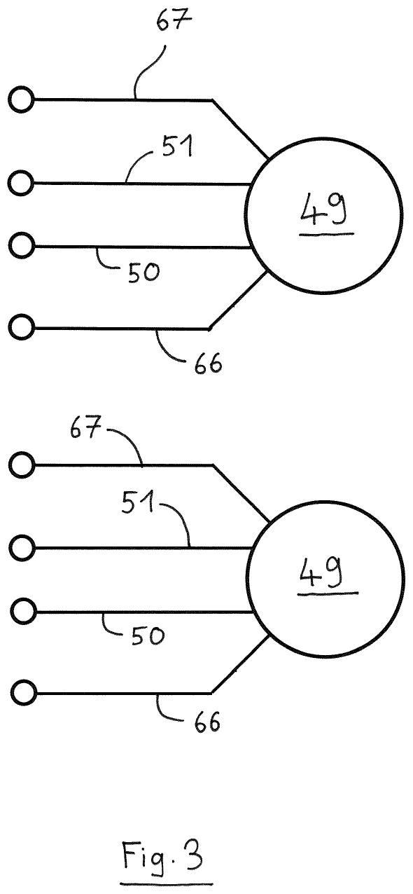

FIG. 3 shows the terminals of a communication device in accordance with FIG. 2;

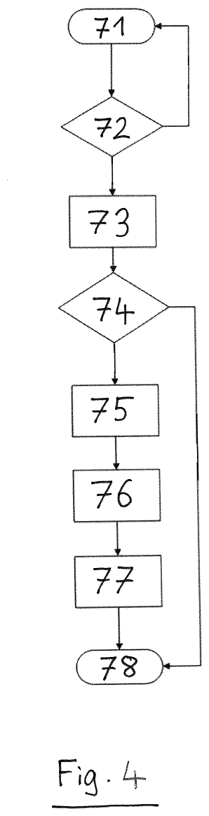

FIG. 4 is a flowchart that shows steps to be performed by a control unit of the communication device shown in FIG. 2; and

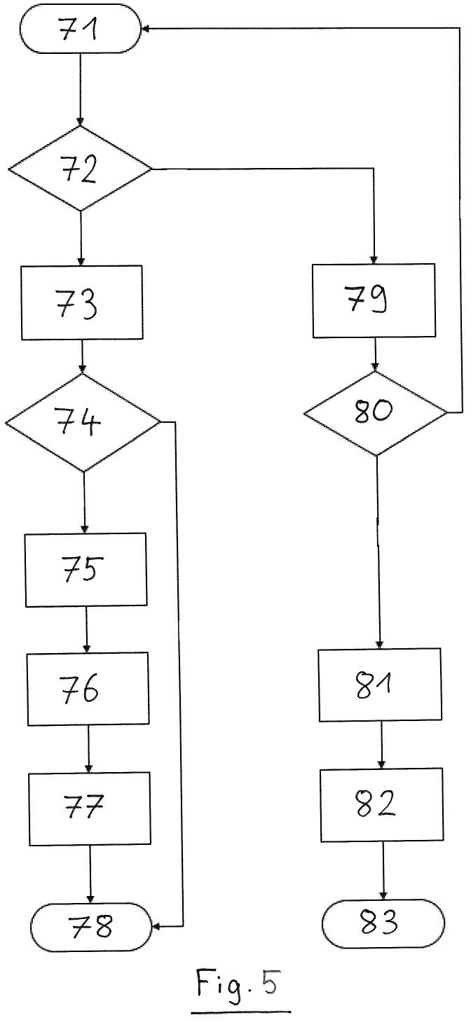

FIG. 5 is a flowchart that shows an alternative sequence of steps to be performed by the control unit of the communication device shown in FIG. 2.

FIG. 1 shows a motion picture camera 13 comprising a camera body 15 to which an interchangeable lens 19 is fastened. This interchangeable lens 19 has three lens rings 20, 21, 22 by means of which respective parameters of the motion picture camera 13 may be set. For example, the first lens ring 20 may be provided to adapt the focus distance of the interchangeable lens 19 through rotations, whereas the focal length may, for example, be settable by means of the second lens ring 21. The third lens ring 22 may, for example, be provided to adapt the aperture. Respective electrical lens setting motors 25, 26 and 27 are provided to be able to adjust the lens rings 20, 21 and 22. The lens setting motors 25, 26, 27 form camera components in the form of accessory devices for the motion picture camera 13. The lens setting motors 25, 26, 27 are mechanically connected to the camera body 15 via a support rod 33. The interchangeable lens 19 is mechanically connected to the camera body 15 via a lens mount 34.

To be able to check a respective image focused on by means of the interchangeable lens 19, and thus the correct alignment of the motion picture camera 13, a viewfinder 35 is further arranged at the camera body 15. Due to the configuration of the motion picture camera 13 with an interchangeable lens 19, different kinds of lenses and lens ring drive units matched thereto may also be connected to the camera body 15.

The setting motor 25 of the first lens ring 20 is connected signal-wise via a first connection cable 37 to the setting motor 26 of the second lens ring 21, whereas the setting motor 26 of the second lens ring 21 is connected signal-wise via a second connection cable 38 to the setting motor 27 of the third lens ring 22. Furthermore, the setting motor 27 of the third lens ring 22 is connected signal-wise via a third connection cable 39 to the lens mount 34 that is in turn connected to a basic control unit, not visible in FIG. 1, of the motion picture camera 13, said basic control unit being accommodated in the camera body 15. A serial bus is thereby formed. The connection cables 37, 38, 39 are preferably four-pole and have an impedance of at least 80 ohms, preferably of at least 100 ohms.

Via the serial bus, an exchange of control signals and/or status signals may take place between the setting motors 25, 26, 27 and the lens mount 34—and thus the basic control unit of the motion picture camera 13. For this purpose, the setting motors 25, 26, 27 and the basic control unit are equipped with respective communication devices 45, one of which is shown in simplified form in FIG. 2.

Each of the communication devices 45 of the setting motors 25, 26, 27 comprises an electronic control unit 47 and, for example, two electrical terminals 49, wherein each of the two electrical terminals 49 has two signal contacts 50, 51 and two energy supply contacts 66, 67 (FIG. 3).

The control unit 47 comprises a controller 53 that has, for each of the two electrical terminals 49, a first transceiver—for example a CAN transceiver 57 —, a second transceiver—for example an SPE transceiver 59—, and a switching device 61. By means of the switching devices 61, it is possible to selectively couple the CAN transceiver 57 or the SPE transceiver 59 to the two signal contacts 50, 51 of the associated electrical terminal 49 in order to transmit and/or receive signals via this electrical terminal 49. The controller 53 is connected to the respective switching device 61 via control lines 62 and is configured to control the coupling of the associated CAN transceiver 57 and of the associated SPE transceiver 59 to the associated signal contacts 50, 51. The communication device 45 may generally have even further arrangements of the controller 53, the CAN transceiver 57, the SPE transceiver 59, the switching device 61 and the electrical terminal 49. For example, a separate controller may be provided for each pair of the CAN transceiver 57 and the SPE transceiver 59. The switching devices 61 may in particular also be configured to switch over the energy supply contacts 66, 67 (FIG. 3). The communication device 45 may also comprise only a single electrical terminal 49 or more than two electrical terminals 49 (for example three or four or even more).

The communication device 45 also has a signal converter 63 that is integrated in the controller 53 and that is configured to selectively convert a CAN signal received at one of the electrical terminals 49 into an SPE signal or to convert an SPE signal received at one of the electrical terminals 49 into a CAN signal. The controller 53 is configured to control the signal converter 63 to convert a CAN signal received at one of the two electrical terminals 49 into an SPE signal in order to output the SPE signal at the other of the two electrical terminals 49. Alternatively or additionally, the controller 53 is configured to control the signal converter 63 to convert an SPE signal received at one of the two electrical terminals 49 into a CAN signal in order to output the CAN signal at the other of the two electrical terminals 49. The communication device 45 may thus serve as an adapter between a CAN-based device and an SPE-based device.

The communication device 45 may moreover have an interface 64 for a signal transmission between the respective communication device 45 and a motor control of the respective setting motor 25, 26, 27. If such an interface 64 is present, the control unit 47 of the communication device 45—in particular its controller 53—may be configured to control a transmission of signals between the two electrical terminals 49 of the communication device 45 and/or between one of the two electrical terminals 49 and the interface 64. The interface 64 may comprise electrical connections and/or electrical contacts.

FIG. 3 additionally shows that each of the two terminals 49 of the communication device 45 in accordance with FIG. 2 has two signal contacts 50, 51 and two energy supply contacts 66, 67 that may, for example, be configured as socket contacts or as plug contacts for an electrical plug-in connection by means of the connection cables 37, 38, 39.

With reference to FIG. 4, a process will be described below that is executed by the control unit 47 of the communication device 45 when the communication device 45 is connected to a further communication device 45 via one of the two electrical terminals 49.

First, in a step 71, a connection with a further communication device 45 is detected, for example by means of a so-called hot plug method. Then, in a step 72, a first check whether a communication according to a first protocol, for example a CAN protocol, is possible with the further communication device 45, is performed. If this is not the case, i.e. if the result of the first check is negative, a return is made to step 71.

However, if the result of the first check is positive, a communication with the further communication device 45 is established in accordance with the CAN protocol in a step 73. Then, in a step 74, a second check whether a communication according to a second protocol, for example an SPE protocol, is also possible with the further communication device 45, is performed. If this is the case, i.e. if the result of the second check is positive, the switching device 61 of the respective electrical terminal 49 is controlled in a step 75 to couple the SPE transceiver 59 to the two signal contacts 50, 51 in order to transmit signals via this electrical terminal 49. The further requirements for a subsequent communication in accordance with the SPE protocol are then negotiated in an (optional) step 76. For example, a master/slave assignment may be negotiated between the connected communication devices 45. In a step 77, a communication with the further communication device 45 is established in accordance with the SPE protocol. In a step 78, a signal transmission takes place in accordance with the established communication.

If the result of the second check is negative in step 74, a jump is made directly to step 78 and communication continues to take place in accordance with the CAN protocol.

FIG. 5 shows an alternative process, wherein the left part of the flowchart shown in FIG. 5 corresponds to FIG. 4. The difference to FIG. 4 is that, in the event of a negative result of the first check in step 72, a jump is not made back to step 71, but rather, in a step 79, the switching device 61 of the respective electrical terminal 49 is controlled to couple the SPE transceiver 59 to the two signal contacts 50, 51 in order to transmit signals via the electrical terminal 49. Subsequently, it is checked in a step 80 whether a communication in accordance with the SPE protocol is possible. If this is not the case, a jump back to step 71 is made. However, if a communication in accordance with the SPE protocol is possible, an SPE communication is initiated in steps 81 to 83 that correspond to steps 76 to 78.

According to one embodiment, not shown, after establishing a communication with the further communication device 45 in accordance with the SPE protocol, an assessment of the signal transmission quality is performed and, in the event of a negative result of the assessment, a communication is established with the further communication device 45 in accordance with the CAN protocol instead of the SPE protocol.

The communication device 45 may be assigned to the motion picture camera 13 (FIG. 1) per se, to one or more of the lens setting motors 25, 26, 27 (FIG. 1), to a setting motor, not shown, for a rotatable polarization filter, to a motor-adjustable camera holder, to a higher-ranking control unit (e.g. a control computer) of a camera system, to a camera stabilization device, to an image stabilization device, to a film set lighting device or to a remote control device (such as a hand-held control unit). The apparatuses mentioned form camera components in this regard.

The invention enables the joint use of SPE-capable camera components and non-SPE-capable CAN-based camera components in complex camera systems, wherein other communication protocols of different kinds are also possible. It is not possible to choose between different terminals in this respect. Equally, different cables do not have to be provided and managed. The user does not have to take care of selecting the communication protocol at all. Instead, the appropriate protocol is always used automatically.

### REFERENCE NUMERAL LIST

13 motion picture camera
15 camera body
19 interchangeable lens
20 first lens ring
21 second lens ring
22 third lens ring
25 setting motor
26 setting motor
27 setting motor
33 support rod
34 lens mount
35 viewfinder
37 first connection cable
38 second connection cable
39 third connection cable
45 communication device
47 control unit
49 electrical terminal
50 signal contact
51 signal contact
53 controller
57 CAN transceiver
59 SPE transceiver
61 switching device
62 control line
63 signal converter
64 interface
66 energy supply contact
67 energy supply contact
71-83 method steps

1. A camera component that is formed by a motion picture camera or an accessory device for a motion picture camera, said camera component comprising
a communication device for transmitting at least one of control signals or status signals of the camera component, wherein the communication device comprises a control unit and at least one electrical terminal, wherein the at least one electrical terminal has at least two energy supply contacts and at least two signal contacts,
wherein the control unit is configured to perform the following steps when the communication device is connected to a further communication device of a further camera component via the at least one electrical terminal:
performing a first check whether a communication in accordance with a first protocol is possible with the further communication device;
then, performing a second check whether a communication in accordance with a second protocol is also possible with the further communication device; and
in the event of a positive result of the second check, establishing a communication with the further communication device in accordance with the second protocol.

2. A camera component according to claim 1,
wherein the control unit is configured, in the event of a positive result of the first check, to at least temporarily establish a communication with the further communication device in accordance with the first protocol.

3. A camera component according to claim 1,
wherein the control unit is configured to repeat the first check in the event of a negative result of the first check.

4. A camera component according to claim 1,
wherein the control unit is configured to perform the second check in the event of a negative result of the first check.

5. A camera component according to claim 1,
wherein the step of establishing a communication with the further communication device in accordance with the second protocol comprises the communication device negotiating a master/slave assignment with the further communication device.

6. A camera component according to claim 1,
wherein the first protocol is a Controller Area Network (CAN) protocol.

7. A camera component according to claim 1,
wherein the second protocol is at least one of a network protocol capable of transmitting time stamps or an Internet Protocol (IP).

8. A camera component according to claim 1,
wherein the second protocol is a Single Pair Ethernet (SPE) protocol.

9. A camera component according to claim 1,
wherein the control unit of the communication device comprises at least one controller, at least one first transceiver corresponding to the first protocol, at least one second transceiver corresponding to the second protocol and at least one switching device,
wherein the at least one switching device is configured to selectively couple the at least one first transceiver or the at least one second transceiver to the at least two signal contacts of the at least one electrical terminal of the communication device in order to transmit signals via the at least one electrical terminal, and
wherein the controller is configured to control the coupling of the at least one first transceiver and the at least one second transceiver to the at least two signal contacts of the communication device.

10. A camera component according to claim 9,
wherein the communication device of the camera component has two electrical terminals and an interface for a signal transmission between the communication device and a component function control unit of the camera component,
wherein the controller of the communication device is configured to control a transmission of signals between the two electrical terminals of the communication device and/or between one of the two electrical terminals and the interface of the communication device.

11. A camera component according to claim 9,
wherein the communication device of the camera component has two electrical terminals, and wherein the control unit of the communication device has the at least one first transceiver and the at least one second transceiver for each of the two electrical terminals.

12. A camera component according to claim 1,
wherein the communication device of the camera component has a plurality of electrical terminals,
wherein the communication device of the camera component has at least one signal converter that is configured to selectively convert a signal received in accordance with the first protocol into a signal in accordance with the second protocol or to convert a signal received in accordance with the second protocol into a signal in accordance with the first protocol, and
wherein the control unit of the communication device is configured to control the at least one signal converter to convert a signal received at one of the plurality of electrical terminals in accordance with the first protocol into a signal in accordance with the second protocol in order to output the signal in accordance with the second protocol at another one of the plurality of electrical terminals of the communication device; and/or to control the signal converter to convert a signal received at one of the plurality of electrical terminals in accordance with the second protocol into a signal in accordance with the first protocol in order to output the signal in accordance with the first protocol at another one of the plurality of electrical terminals of the communication device.

13. A camera component according to claim 1,
wherein the control unit is configured to perform an assessment of the signal transmission quality after establishing a communication with the further communication device in accordance with the second protocol and, in the event of a negative result of the assessment, to establish a communication with the further communication device in accordance with the first protocol instead of the second protocol.

14. A camera component according to claim 1,
wherein the at least one electrical terminal of the communication device has only two energy supply contacts and two signal contacts.

15. A camera component according to claim 1,
wherein the camera component is formed by an accessory device for a motion picture camera, said accessory device comprising a setting motor for a camera lens, a motorized optical filter, a motor-adjustable camera holder, a camera stabilization device, an image stabilization device, a remote control device or a film set lighting device.

16. A camera component that is formed by a motion picture camera or an accessory device for a motion picture camera, said camera component comprising
a communication device for transmitting at least one of control signals or status signals of the camera component, wherein the communication device comprises a control unit and at least one electrical terminal, wherein the at least one electrical terminal has at least two energy supply contacts and at least two signal contacts,
wherein the control unit performs the following steps when the communication device is connected to a further communication device of a further camera component via the at least one electrical terminal:
performing a first check whether a communication in accordance with a first protocol is possible with the further communication device;
in the event of a negative result of the first check, repeating the first check;
in the event of a positive result of the first check, at least temporarily establishing a communication with the further communication device in accordance with the first protocol and performing a second check whether a communication in accordance with a second protocol is also possible with the further communication device;
in the event of a negative result of the second check, continuing the communication with the further communication device in accordance with the first protocol; and
in the event of a positive result of the second check, establishing a communication with the further communication device in accordance with the second protocol.

17. A camera component according to claim 16,
wherein the first protocol is a Controller Area Network (CAN) protocol; and
wherein the second protocol is at least one of a network protocol capable of transmitting time stamps or an Internet Protocol (IP) or a Single Pair Ethernet (SPE) protocol.

18. A camera component that is formed by a motion picture camera or an accessory device for a motion picture camera, said camera component comprising
a communication device for transmitting at least one of control signals or status signals of the camera component, wherein the communication device comprises a control unit and at least one electrical terminal, wherein the at least one electrical terminal has at least two energy supply contacts and at least two signal contacts,
wherein the control unit performs the following steps when the communication device is connected to a further communication device of a further camera component via the at least one electrical terminal:
performing a first check whether a communication in accordance with a first protocol is possible with the further communication device;
in the event of a positive result of the first check, at least temporarily establishing a communication with the further communication device in accordance with the first protocol and performing a second check whether a communication in accordance with a second protocol is also possible with the further communication device;
in the event of a negative result of the second check, continuing the communication with the further communication device in accordance with the first protocol;
in the event of a positive result of the second check, establishing a communication with the further communication device in accordance with the second protocol;
in the event of a negative result of the first check, performing an alternative second check whether a communication in accordance with the second protocol is possible with the further communication device;
in the event of a negative result of the alternative second check, repeating the first check; and
in the event of a positive result of the alternative second check, establishing a communication with the further communication device in accordance with the second protocol.

19. A camera component according to claim 18,
wherein the first protocol is a Controller Area Network (CAN) protocol; and
wherein the second protocol is at least one of a network protocol capable of transmitting time stamps or an Internet Protocol (IP) or a Single Pair Ethernet (SPE) protocol.
